(19) United States
(12) Patent Application Publication
(10) Pub. No.: US 2023/0195540 A1
(43) Pub. Date: Jun. 22, 2023

(54) METHOD AND APPARATUS FOR INTERACTION BETWEEN DEVICES

(71) Applicant: Mobility Asia Smart Technology Co. Ltd., Beijing (CN)

(72) Inventors: Tong QU, Beijing (CN); Shuai TANG, Beijing (CN); Yue YANG, Beijing (CN); Hanzhang LI, Beijing (CN)

(21) Appl. No.: 18/083,780

(22) Filed: Dec. 19, 2022

(30) Foreign Application Priority Data
Dec. 21, 2021 (CN) 202111573665.8

(51) Int. Cl. G06F 9/54; H04N 7/18; G06F 3/14

(52) U.S. Cl. CPC G06F 9/541; G06F 3/1423; H04N 7/183

(57) ABSTRACT

The present invention relates to a method and apparatus for interaction between devices. The method comprises: receiving an image related to a first application from a first device, the image being captured by a camera from a screen of the first device; searching a second device for a second application according to the received image; and after the second application is found from the second device, running the second application in the second device, wherein the first application and the second application are the same applications or are applications of the same type.

### CROSS-REFERENCE TO RELATED APPLICATION

This application claims the priority to Chinese Patent Application No. 202111573665.8, filed on Dec. 21, 2021, the content of which is incorporated herein by reference in its entirety.

### TECHNICAL FIELD

The present invention relates to a method and apparatus for interaction between devices, and more particularly, to a method and apparatus for interaction between devices on the basis of image recognition.

### BACKGROUND

Currently, it is common to implement connection or interaction between different devices, for example, performing connection or interaction between a mobile phone of a user and a vehicle-mounted system in a vehicle. However, currently, there are many limitations in implementation of connection or interaction between different devices. For example, a direct connection by means of a cable is limited by the length of the cable and the distance between devices and has high cost; a Bluetooth-based connection is limited by the distance between devices; and the quality of a Wi-Fi-based connection may be affected by the stability of Wi-Fi. In addition, current connection manners generally require a user to manually switch between devices. The method that requires users to perform manual operations is not only inconvenient, but also causes potential safety hazards sometimes. For example, while the user is driving a vehicle, the manual switching between, for example, a mobile terminal and a vehicle-mounted system in the vehicle (e.g., the user touches the screen of the mobile terminal or the vehicle-mounted system with a finger) may cause potential safety problems.

Therefore, how to implement interaction between devices efficiently and stably becomes the concern.

### SUMMARY

The Summary is provided to introduce a set of concepts that are further described below in the Detailed Description of the Embodiments. The Summary is not intended to identify key features or essential features of the subject matter, nor is it intended to be used to limit the scope of the subject matter.

The objective of the present application is to provide a method and apparatus for interaction between devices, so as to at least partially overcome the drawbacks of the prior art.

The embodiments of the present application provide a method for interaction between devices, comprising: receiving an image related to a first application from a first device, the image being captured by a camera from a screen of the first device; searching a second device for a second application according to the received image; and after the second application is found from the second device, running the second application in the second device, wherein the first application and the second application are the same applications or are applications of the same type.

The embodiments of the present application further provide an apparatus for interaction between devices, comprising: a receiving module, configured to receive an image related to a first application from a first device, the image being captured by a camera from a screen of the first device; a search module, configured to search a second device for a second application according to the received image; and a running module, configured to run the second application in the second device after the second application is found from the second device, wherein the first application and the second application are the same applications or are applications of the same type.

A device for interaction between devices according to the embodiments of the present application, comprising: a processor; and a memory, configured to store an executable instruction, wherein the executable instruction, when executed, causes the processor to execute the described method.

A machine-readable medium according to an embodiment of the present application, on which an executable instruction is stored, wherein when the executable instruction is executed, the machine is caused to execute the described method.

It can be seen from the description above that, the solutions of the embodiments of the present application realize interaction between devices in a wireless manner, so that no additional cable is required and it is convenient for a user to use. In addition, by using an image recognition technology, the implementation of the solutions does not rely on a wireless signal or is not limited to a wireless signal, and problems such as weak signal quality and unstable connection cannot be encountered. Since the user does not need to perform additional manual operations, it is user-friendly and easy to implement.

It should be noted that one or more of the above aspects include the following detailed description and the features particularly pointed out in the claims. Certain illustrative features of the one or more aspects are described in details in the following description and drawings. These features merely indicate various ways in which the principles of the various aspects can be employed, and the present disclosure is intended to comprise all such aspects and equivalents thereof.

### BRIEF DESCRIPTION OF THE DRAWINGS

The disclosed aspects will hereinafter be described in conjunction with the accompanying drawings, and the accompanying drawings are provided to illustrate and not to limit the disclosed aspects.

FIG. 1 shows an architecture diagram of a system for interaction between devices according to an embodiment of the present application;

FIG. 2 shows a schematic flowchart of a method for interaction between devices according to an embodiment of the present application;

FIG. 3 shows a schematic flowchart of a method for interaction between devices according to another embodiment of the present application;

FIG. 4 shows a schematic diagram of an apparatus for interaction between devices according to an embodiment of the present application; and

FIG. 5 shows a schematic diagram of a device for interaction between devices according to an embodiment of the present application.

### DETAILED DESCRIPTION OF THE EMBODIMENTS

The present disclosure will now be discussed with reference to various exemplary embodiments. It should be understood that the discussion of these embodiments is intended only to enable a person killed in the art to better understand and thereby implement the embodiments of the present disclosure, but is not intended to teach any limitations to the scope of the present disclosure.

To enhance interaction between devices, solutions have been currently used to facilitate connection and interaction between different devices. For example, a manner such as gesture recognition or voice recognition is used to connect different devices to one another. However, the technique of using gesture recognition to facilitate the connection between devices is relatively complicated, has low possibility of integration between devices, requires more operations, and will increase the cost of the device; the use of voice recognition may distract the user, especially when the user is driving a vehicle, because it requires the user to give instructions in the form of voice, which may cause safety problems, and in addition, it is inconvenient and unfriendly to hearing-impaired and speech-impaired people. In view of this, the present application proposes a method which is simple and practicable and has low coat, i.e. facilitating interaction between different devices on the basis of image recognition. Various embodiments of the present disclosure will be described in details below with reference to the accompanying drawings.

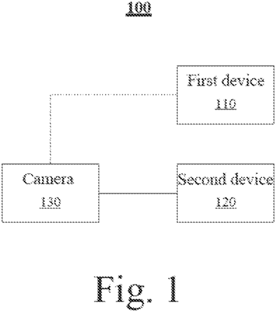

FIG. 1 shows an architecture diagram of a system 100 for interaction between devices according to an embodiment of the present application. As shown in FIG. 1, the system 100 may include a first device 110, a second device 120 and a camera 130, wherein the camera 130 may capture an image from the first device 110 (in FIG. 1, the two are shown to be connected by a dotted line) and be connected to the second device 120 (in FIG. 1, the two are shown to be connected by a solid line). In some examples, the first device 110 may be any of a mobile terminal such as a mobile phone, a laptop computer, a desktop computer, a handheld computing device, a tablet computer, etc. The second device 120 may be any one of a vehicle-mounted system installed in a means of transport (e.g., a vehicle), a television, a desktop computer, a laptop computer, a handheld computing device, a tablet computer, etc.

In some examples, the camera 130 may be placed near the second device 120 or embedded in the second device 120 as a component of the second device 120, and preferably, may be placed at a location where an image on the screen of the first device 110 can be captured easily, e.g., a location facing the first device 110 or a location of a user holding the first device 110. The camera 130 may be configured to capture an image on the screen of the first device 110, and transmit the captured image to the second device 120.

After having received an image from the camera 130, for example, using a receiver, the second device 120 may search the second device for the second application according to the received image.

By way of example, by performing image matching or comparison of the received image with images stored in a database, an application corresponding to the matched image may be found from a memory of the second device 120 or an application database or application market as the second application.

In another example, the received image may be identified by using, for example, an image recognition module, so as to extract information included in the image, wherein the information includes but is not limited to the name or identifier of an application corresponding to the image, content presented on the screen of the first device during running of the application, etc. By way of example, the image presented on the screen of the first device 110 is an interface regarding that a music player A is playing music B. After the second device 120 receives the image captured by the camera 130 from the screen of the first device 110, the information contained in the image, i.e., the application name (music player A) and/or the content (song B), may be extracted.

In this example, after the application identifier information included in the image is extracted, a memory or an application database or an application market of the second device 120 may be searched for an application, which corresponds to an application name or identifier and included in the information, by using, for example, the processor of the second device 120. When the corresponding application is found, the processor of the second device 120 can activate the application to run, on the second device 120, an application corresponding to the application running on the first device 110. For example, referring to the example above, when it is presented on the screen of the first device 110 that the music player A is running on the first device 110, the music player A may be run on the second device 120 on the basis of an image captured by the camera 130 from the screen of the first device 110. In another example, in cases where there is no music player A but another music player A′ in the second device 120, an alternative music player A′ may be run on the second device 120 on the basis of an image captured by the camera 130 from the screen of the first device 110 and related to the music player A.

In another example, when the application identifier and the content in the application are extracted from the image, a memory or an application database or an application market of the second device 120 may be searched for an application, which corresponds to an application name or identifier and is included in the information, by using, for example, the processor of the second device 120. When the corresponding application is found, the processor of the second device 120 can activate the application to run, on the second device 120, an application corresponding to the application running on the first device 110, and may apply, according to the extracted content in the application, the extracted content in the application while running the application on the second device 120. For example, referring to the example above, when it is presented on the screen of the first device 110 that the song B is being played using the music player A, on the basis of an image captured by the camera 130 from the screen of the first device 110, the music player A may be run on the second device 120 and the song B may be played using the music player A.

It should be understood that, although in FIG. 1, the camera 130 is shown to be separate from second device 120, the camera 130 may also be provided in the second device 120.

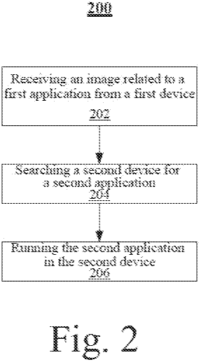

FIG. 2 shows a schematic flowchart of a method 200 for interaction between devices according to an embodiment of the present application. In some examples, a method 200 shown in FIG. 2 may be implemented in the second device 120 of FIG. 1. For example, by setting a switch in the second device, the execution process of the method 200 may be started or ended by activating or deactivating the switch. In some examples, the switch may be any one of: a soft-button provided in the second device, a startup program provided in the second device, and a hard-button provided on or near the second device. In some embodiments, the switch may be connected to the camera, to initiate the camera function when the switch is activated. In a preferred embodiment of the present application, the second device may be a vehicle-mounted system installed in a vehicle.

As shown in FIG. 2, in block 202, an image related to a first application is received from a first device. In a preferred embodiment of the present application, the first device may be a mobile terminal such as a mobile phone. In some examples, an image related to the first application may be captured from the screen of the first device by using a camera provided near or in the second device, and the camera may transmit the captured image to the second device. In some examples, the camera may be configured to be automatically adjustable (e.g. may be automatically rotated to a suitable position or automatically adjusting the photographing angle), so that a complete or clear image can be captured from the screen of the first device. In some examples, the first application may be an application which is running on the first device. In some other examples, the first application may be an application installed or provided on the first device but not currently activated or running; in still other examples, the first application may be an application that is not currently installed on the first device, but a picture having identifier information of the first application is stored on the first device. In some examples, the image related to the first application may include a screen interface of the first application which is currently running on the first device; in some other examples, the image related to the first application may include a screen interface having the identifier or name of the first application; and in still other examples, the image related to the first application may comprise a picture having the identifier or name of the first application.

For example, the first application is an application which is running on the first device, an image captured by a camera from a screen of the first device (for example, a mobile phone) may be an image of the first application which is running on the first device, for example, an image including a current running interface of the first application.

In block 204, a second device may be searched for a second application according to the received image. For example, the received image may be identified by the image recognition module, to extract information related to the first application and contained in the image, and a second device is searched for a second application according to the extracted information. In one example, the extracted information may include the name or identifier of the first application. In another example, the extracted information may also include the content presented on the screen of the first device during running of the first application. In some other examples, by performing image matching or comparison of the received image with images stored in the second device (e.g. a database of the second device), the application corresponding to the stored matched image may be found as the second application.

In some examples, the second application may be an application the same as the first application, or may be an application of the same type as the first application, and is pre-downloaded or stored in the second device. By way of example, if the first application is a call application C, the second application may be a call application C or another call application C′; if the first application is a music player A, the second application may be a music player A or another music player A′; if the first application is a map navigation application M, the second application may be a map navigation application M or another map navigation application M′.

After the second application is found in block 204, in block 206, the second application is started or run in the second device, for example, the second application may be triggered by instructions to run. For example, the first application is an application which is running on the first device, after the second application is found in the second device, starting or running the second application in the second device may include any one or more of: continuing to run, in the second application, the function to be executed by the first application, or re-running the corresponding function which has been executed or is being executed in the first application.

It should be understood that the steps shown in FIG. 2 are merely exemplary, and in other embodiments, additional steps may be added or other steps may be substituted for the steps shown. For example, the method 200 may further include: after the second application is run in the second device, applying, in the second application, content that is included in the extracted information and is presented on the screen of the first device during running of the first application. Optionally, the method 200 may further include presenting an indication by a presentation unit of the second device when the second application is not found in the second device, etc.

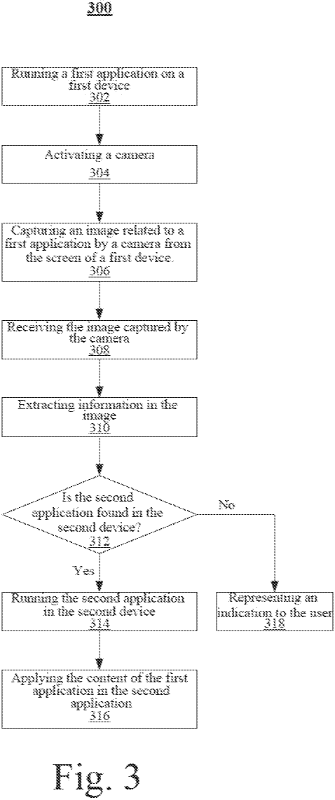

FIG. 3 shows a schematic flowchart of a method 300 for interaction between devices according to another embodiment of the present application. In some examples, the method 300 shown in FIG. 3 may be implemented in a system 100.

As shown in FIG. 3, the method 300 may include running a first application on a first device in block 302. By way of example, a music player A runs on a mobile phone of a user, wherein the music player A is playing a song B.

In block 304, the camera is activated, for example, the camera can be activated by activating a switch such as a soft-button, a hard-button or a startup program. In some examples, activating the soft-button may be implemented by, but is not limited to, touching or pressing an icon on the screen of the second device. In some other examples, the hard-button may include, but is not limited to, a mechanical rotation button, a push button, a toggle switch, a capacitive touch button, etc. In some other examples, the startup program of activating a switch may be implemented by, but not limited to, downloading the startup program to a second device, clicking or opening a program icon, and activating the startup program to activate the switch.

In block 306, an image related to a first application is captured by a camera from the screen of a first device. In some examples, the image may include the identifier (e.g. icon) or name of the first application, and/or content that is presented on the screen during running of the first application. In some examples, the captured image may include an image of a first application which is running on a first device, such as a current running interface of the first application presented on the screen of the first device.

In block 308, at the second device, the image captured by the camera, i.e. the image related to the first application, is received from the camera, for example, by using receiver.

In block 310, image recognition is performed on the received image, to extract information contained in the image and related to the first application, such as the identifier or name of the first application, and content presented on the screen during running of the first application.

In block 312, on the basis of the extracted information, the second device is searched for a second application corresponding to the first application, wherein the second application may be an application the same as the first application, or may be an application of the same type as the first application.

In block 314, if the second application is found in block 312 (“YES” shown in FIG. 3), the second application is started or run in the second device.

Optionally, in block 316, after the second application is run, on the basis of the content that is included in the information extracted in block 310 and presented on the screen during running of the first application, the content of the first application is applied in the second application. By way of example, assume that the first application of the first device is a music player A on a mobile phone and a song B is being played in the music player A, and that a second device is a vehicle-mounted system, then images captured by a camera from the screen of a mobile phone comprise interfaces having the name of the music player A and the name of the song B, so that according to the captured images, the music player A (or optionally another music player A′) may be found and run in the vehicle-mounted system, and the song B can be played on the music player A (or optionally another music player A′) in the vehicle-mounted system.

If the second application is not found in the second device in block 312 (as shown in ‘No’ of FIG. 3), then in block 318, an indication is presented to the user by a presentation unit of the second device. The indication may include, but is not limited to, the following: an option regarding whether to download the second application over the network, a notification regarding that the second application is not found, an option regarding whether to run an alternative application when the second application is not found, etc. In one example, these indications may be presented to the user in a visual form by a display of the second device; in another example, these indications may be presented to the user in a voice form by a speaker of the second device; in still other examples, these indications may be presented to the user by incorporating both a display and a speaker of the second device, etc.

It should be understood that, the order of the method steps shown in FIG. 3 is merely exemplary, and in other embodiments, the order of the method steps may be parallel or even may be reversed. For example, the steps of blocks 302 and 304 may be executed in parallel or the steps of block 304 may be executed prior to the steps of block 302.

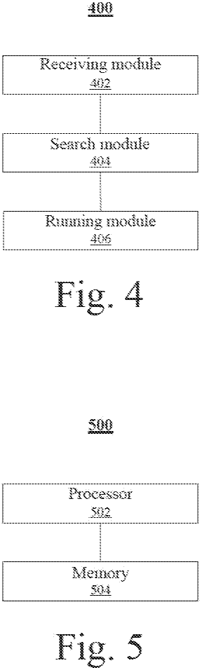

FIG. 4 shows a schematic diagram of an apparatus 400 for interaction between devices according to an embodiment of the present application. The apparatus 400 shown in FIG. 4 may be implemented using software, hardware, or a combination of software and hardware. In some examples, the apparatus 400 may include or be implemented in a second device such as a vehicle-mounted system.

As shown in FIG. 4, the apparatus 400 may include a receiving module 402, a search module 404, and a running module 406.

In some examples, the receiving module 402 may be configured to receive an image related to a first application from a first device, the image being captured by a camera from a screen of the first device. In some examples, the image may include a current running interface of a first application which is running on the first device. In some examples, the camera may be provided in or near the second device and configured to be automatically adjustable, so that a complete image can be captured from the screen of the first device.

The search module 404 may be configured to search a second device for a second application according to the received image. In some examples, the apparatus 400 may also include an extraction module, configured to extract information related to the first application from the received image by recognizing the received image. The search module 404 may be further configured to search the second device for the second application on the basis of the extracted information. In some examples, the information related to the first application may include one or more of the name of the first application, the identifier of the first application, etc. In some other examples, the information may also include the content presented on the screen of the first device during running of the first application. In another example, the search module 404 may be further configured to perform image matching of the received image with images stored in the second device, to search the application corresponding to the stored matched image as the second application.

The running module 406 may be configured to run the second application in the second device after the second application is found from the second device, wherein the first application and the second application are the same applications or are applications of the same type. In some examples, running the second application may include any one or more of: continuing to run, in the second application, the function to be executed by the first application, and re-running, in the second application, the function which has been executed or is being executed by the first application, etc.

Optionally, the apparatus 400 can further include an application module, configured to apply, in the second application, the content presented on the screen of the first device during the running of the first application after the second application is activated in the second device.

In addition, the apparatus 400 may also include a presentation module configured to present an indication when the second application is not found in the second device, the indication comprising any one or more of the following: an option regarding whether to download the second application, a notification regarding that the second application is not found, and an option regarding whether to run an alternative application when the second application is not found.

In some examples, the first device may be a mobile terminal such as a mobile phone, and the second device may be a vehicle-mounted system installed in a vehicle.

FIG. 5 shows a schematic diagram of a device 500 for interaction between devices according to an embodiment of the present application.

As shown in FIG. 5, the device 500 may include a processor 502 and a memory 504, wherein the memory 504 is configured to store an executable instruction, and when the executable instruction is executed, the processor 502 is enabled to execute method 200 shown in FIG. 2 and/or the method 300 shown in FIG. 3. In some examples, the device 500 may be included in or implemented in a second device such as a vehicle-mounted system.

An embodiment of the present invention further provides a machine-readable medium, on which an executable instruction is stored, and when the executable instruction is executed, the machine is enabled to execute the method 200 shown in FIG. 2 and/or the method 300 shown in FIG. 3.

It should be understood that all operations in the methods described above are merely exemplary, and the present disclosure is not limited to any operation in the methods or the order of these operations, but should cover all other equivalent transformations under the same or similar concepts.

It should also be appreciated that all of the modules in the described apparatus may be implemented in a variety of ways. The modules may be implemented as hardware, software, or a combination thereof. In addition, any of these modules may be further functionally divided into sub-modules or combined together.

The processor has been described in connection with various apparatus and methods. These processors may be implemented using electronic hardware, computer software, or any combination thereof. Whether these processors are implemented as hardware or software will depend on the particular application and the overall design constraints applied on the system. As examples, a processor, any portion of a processor, or any combination of processors provided in this disclosure may be implemented as a microprocessor, a microcontroller, a digital signal processor (DSP), a field programmable gate array (FPGA), a programmable logic device (PLD), a state machine, a gated logic, a discrete hardware circuit, and other suitable processing components configured to perform the various functions described in the present disclosure. The functions of a processor, any portion of a processor, or any combination of processors disclosed in the present disclosure may be implemented as software executed by a microprocessor, a microcontroller, a DSP, or other suitable platform.

A person skilled in the art should understand that various embodiments disclosed above can make various modifications and variations without departing from the spirit of the present invention, and these modifications and variations should belong to the scope of protection of the present invention, and the scope of protection of the present invention should be defined by the claims.

1. A method for interaction between devices, comprising:
receiving an image related to a first application from a first device, the image being captured by a camera from a screen of the first device;
searching a second device for a second application according to the received image; and
after the second application is found from the second device, running the second application in the second device, wherein the first application and the second application are the same applications or are applications of the same type.

2. The method according to claim 1, wherein searching a second device for the second application according to the received image comprises:
extracting information related to the first application from the received image by recognizing the received image; and
searching the second device for the second application on the basis of the extracted information.

3. The method according to claim 2, wherein the information related to the first application comprises one or more of: the name of the first application, and the identifier of the first application.

4. The method according to claim 3, wherein the information further comprises content presented on the screen of the first device during running of the first application,
the method further comprises, after the second application is run in the second device, applying, in the second application, the content presented on the screen of the first device during running of the first application.

5. The method according to claim 1, wherein searching a second device for the second application according to the received image comprises:
performing image matching of the received image with images stored in the second device, to search an application corresponding to the stored matched image as the second application.

6. The method according to claim 1, wherein the first application is running on the first device, and wherein the image captured from the screen of the first device by using the camera is an image of the first application which is running on the first device, and after the second application is found from the second device, running the second application in the second device comprises: continuing to run, in the second application, the function to be executed by the first application, or re-running, in the second application, the corresponding function executed in the first application.

7. The method according to claim 1, wherein the first device is a mobile terminal, and the second device is a vehicle-mounted system in a vehicle.

8. The method according to claim 1, wherein when the second application is not found in the second device, presenting an indication by a presentation unit of the second device, the indication comprising any one or more of the following: an option regarding whether to download the second application, a notification regarding that the second application is not found, and an option regarding whether to run an alternative application when the second application is not found.

9. An apparatus for interaction between devices, comprising:
a receiving module, configured to receive an image related to a first application from a first device, the image being captured by a camera from a screen of the first device;
a search module, configured to search a second device for a second application according to the received image; and
a running module, configured to run the second application in the second device after the second application is found from the second device, wherein the first application and the second application are the same applications or are applications of the same type.

10. The apparatus according to claim 9, further comprising:
an extraction module, configured to extract information related to the first application from the received image by recognizing the received image,
wherein the search module is further configured to search the second device for the second application on the basis of the extracted information.

11. The apparatus according to claim 10, wherein the information related to the first application comprises one or more of: the name of the first application, and the identifier of the first application.

12. The apparatus according to claim 11, wherein the information further comprises content presented on the screen of the first device during running of the first application,
the apparatus further comprises: an application module, configured to apply, in the second application and after the second application is activated in the second device, the content presented on the screen of the first device during running of the first application.

13. The apparatus according to claim 9, wherein the search module is further configured to:
perform image matching of the received image with images stored in the second device, to search an application corresponding to the stored matched image as the second application.

14. The apparatus according to claim 9, wherein the first device is a mobile terminal, and the second device is a vehicle-mounted system in a vehicle.

15. The apparatus according to claim 9, the apparatus further comprises a presentation module configured to present an indication when the second application is not found in the second device, the indication comprising any one or more of the following: an option regarding whether to download the second application, a notification regarding that the second application is not found, and an option regarding whether to run an alternative application when the second application is not found.

16. A device for interaction between devices, comprising:
a processor; and
a memory, configured to store an executable instruction, wherein the executable instruction, when executed, causes the processor to execute the method according to claim 1.

17. A machine-readable medium, on which an executable instruction is stored, wherein when the executable instruction is executed, the machine is caused to execute the method according to claim 1.
